(19) United States
(12) Patent Application Publication
(10) Pub. No.: US 2008/0291034 A1
(43) Pub. Date: Nov. 27, 2008

(54) Method, System and Apparatus for Monitoring in a Vehicle Horn System

(75) Inventor: Jeffrey D. Kernwein, Cedar Rapids, IA (US)

Correspondence Address: THE WEBB LAW FIRM, P.C., 700 KOPPERS BUILDING, 436 SEVENTH AVENUE, PITTSBURGH, PA, 15219, US

(73) Assignee: WABTEC HOLDING CORP., Wilmerding, PA (US)

(21) Appl. No.: 11/874,521

(22) Filed: Oct. 18, 2007

Related U.S. Application Data
(60) Provisional application No. 60/931,653, filed on May 24, 2007.

(51) Int. Cl. G08B 21/00

(52) U.S. Cl. 340/626; 340/540; 340/632; 340/635

(57) ABSTRACT

A system for monitoring in a horn system of a vehicle having at least one activatable mechanism for causing a horn to sound. The system includes at least one monitoring device in communication with the at least one activatable mechanism, at least one component of the horn system or any combination thereof. The at least one monitoring device measures the presence or absence of at least one measurable characteristic in the horn system, and transmits a signal based upon the results of the measurement. A method for monitoring in a horn system of a vehicle is also provided.

### CROSS REFERENCE TO RELATED APPLICATIONS

This application claims the benefit of priority from U.S. Provisional Patent Application No. 60/931,653, filed May 24, 2007, which is incorporated herein by reference in its entirety.

### BACKGROUND OF THE INVENTION

1. Field of the Invention

The present invention relates generally to vehicle control systems and, in particular to a method, system and apparatus for monitoring in a horn system, such as a locomotive horn system, and for ascertaining and verifying the integrity and proper operation and execution of a horn system, such as an automated horn sequencing system and the like.

2. Description of Related Art

For the safety of pedestrians and motorists, locomotive operators are required to activate the locomotive horn as they approach and proceed through grade crossings and other similar junctures. Failure of the operator to properly activate the locomotive horn may lead to dire consequences to persons at or near the crossing. When traversing the crossing, the operator must activate the horn according to certain required sequences, or horn “blasts”. The Federal Railroad Administration has promulgated regulations that address when and how horns are to be sounded, i.e., the horn activation “sequence”. In particular, the required horn activation sequence (including distance, timing, duration, etc.) is set forth in 49 C.F.R. § 222.21. Such sequencing according to the regulations ensures that both pedestrians and motorists at or near the crossing are appropriately warned that a train is approaching.

According to the prior art, certain systems have been developed that automatically activate the locomotive horn in accordance with the regulations as the train traverses the crossing. Specifically, and as disclosed in U.S. Pat. Nos. 6,609,049 and 6,824,110 (both to Kane et al.), such systems use an on-board database of locations that require horn activation, as well as a positioning system, e.g., a Global Positioning System (GPS), to determine the train's position. Based upon the upcoming activation location and train position, the locomotive horn is automatically activated at a determined point and in compliance with the regulations.

According to the prior art, there are various methods, apparatus and systems available for automated or augmented horn activation, as well as associated diagnostic, testing, tuning and adjustment functions for vehicle horns and control systems. For example, see U.S. Pat. Nos. 6,457,682 to Anderson et al.; 6,088,635 to Cox et al.; 5,966,078 to Tanguay; 5,414,406 to Baxter; 5,266,921 to Wilson; 5,131,612 to Skantar; 4,004,111 to Turlais; and U.S. Application Publication Nos.: 2006/0015224 to Hilleary; and 2005/0131600 to Quigley et al.

As discussed, the activation of the horn is of the utmost importance within the context of the railroad industry. Accordingly, there is a need in the industry to provide a diagnostic system that is capable of monitoring and verifying the integrity of the locomotive horn system. There is a further need in the art to provide a diagnostic system that is capable of monitoring and verifying proper and appropriate activation of the locomotive horn. In addition, other vehicles and industries that require the appropriate operation of horns and other safety equipment also may have need of a system that monitors and verifies the proper operation of such equipment.

### SUMMARY OF THE INVENTION

It is one object of the present invention to provide a method, system and apparatus for monitoring in a vehicle horn system that overcomes the drawbacks and deficiencies of the prior art. It is another object of the present invention to provide a method, system and apparatus for monitoring and verifying the integrity of a vehicle horn system that overcomes the drawbacks and deficiencies of the prior art. It is a further object of the present invention to provide a method, system and apparatus for monitoring and verifying the appropriate activation and operation of a vehicle horn that overcomes the drawbacks and deficiencies of the prior art. It is a still further object of the present invention to provide a method, system and apparatus for monitoring in a vehicle horn system that ensures that the horn system is operational, and the horn appropriately activated. It is yet another object of the present invention to provide a method, system and apparatus for monitoring in a locomotive horn system.

In one preferred and non-limiting embodiment, provided is a system for monitoring in a horn system of a vehicle having at least one activatable mechanism for causing a horn to sound. The system includes at least one monitoring device in communication with the at least one activatable mechanism, at least one component of the horn system or any combination thereof. The at least one monitoring device measures the presence or absence of at least one measurable characteristic in the horn system and transmits a signal based upon the results of the measurement.

In another preferred and non-limiting embodiment, provided is a method for monitoring in a horn system of a vehicle having at least one activatable mechanism for causing a horn to sound. The method includes measuring the presence or absence of at least one measurable characteristic in the horn system, and transmitting a signal based upon the results of the measurement.

In a further preferred and non-limiting embodiment, provided is a system for monitoring in a horn system of a vehicle having an on-board computer configured to transmit a signal to at least one activatable valve for causing a horn to sound. The system includes at least one monitoring device in communication with the on-board computer, the at least one activatable valve, at least one component of the horn system or any combination thereof. The at least one monitoring device measures the presence or absence of at least one measurable characteristic in the horn system and transmits a signal based upon the results of the measurement.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is a schematic diagram of one embodiment of a method, system and apparatus for monitoring in a locomotive horn system according to the principles of the present invention;

FIG. 2 is a schematic diagram of another embodiment of a method, system and apparatus for monitoring in a locomotive horn system according to the principles of the present invention;

FIG. 3 is a schematic diagram of a further embodiment of a method, system and apparatus for monitoring in a locomotive horn system according to the principles of the present invention; and

FIG. 4 is a schematic diagram of a further embodiment of a method, system and apparatus for monitoring in a locomotive horn system according to the principles of the present invention.

### DESCRIPTION OF THE PREFERRED EMBODIMENTS

The present invention will now be described with reference to the accompanying figures. It is to be understood that the specific system illustrated in the attached figures and described in the following specification is simply an exemplary embodiment of the present invention. Hence, specific dimensions and other physical characteristics related to the embodiments disclosed herein are not to be considered as limiting. It is also to be understood that the invention may assume various alternative variations and step sequences, except where expressly specified to the contrary.

The presently-invented system 10 is useful in connection with a variety of applications that require some assurance that a horn 12 or other similar warning device has been or can be activated. Further, the system 10 is useful in connection with any number of vehicles and alarm systems in a variety of industries. Therefore, the system 10 of the present invention should not be limited to only one type of vehicle, e.g., train, or any one industry or transit system, e.g., the railroad industry. Still further, the system 10 is useful in connection with different warning devices that are required to be operational, and are activated through or provide some measurable characteristic, whether physical, electrical, etc. Various preferred and non-limiting embodiments are illustrated in schematic form in FIGS. 1-4.

In one preferred and non-limiting embodiment, and as illustrated in FIG. 1, the system 10 of the present invention is configured to monitor in a horn system 14 of a vehicle (not shown). The horn system 14 includes at least one activatable mechanism 16 for causing the horn 12 to sound. In this embodiment, the system 10 includes at least one monitoring device 18, which is in communication with the at least one activatable mechanism 16 and/or some component of the horn system 14. The monitoring device 18 is configured or adapted to measure the presence or absence of at least one measurable characteristic in the horn system 14, as well as transmit some signal, e.g., an analog signal, a digital signal, data, etc., based upon the results of this measurement.

In a further non-limiting embodiment, and as discussed hereinafter, the system 10 is particularly useful in the railroad industry in order to ensure that a horn 12 can be activated (whether automatically or manually) when the locomotive (not shown) is encountering a position on the track that requires such activation. Further, it is to be understood that the system 10 may be integrated with an originally-installed train control system computer or on-board computer (OBC) 20 or, alternatively, may be installed as an after-market component and system. Further, the system 10 may be embodied as a hardware unit with the necessary software and electrical communication connections for integration with the OBC 20 and/or similar train control system. Still further, the system 10 may be a subsystem or component of the overall train control system. Accordingly, it is to be understood that either the OBC 20 and/or the overall train control system may be updated with the necessary software for implementing the various aspects and functions of the system 10 of the present invention.

In one preferred and non-limiting embodiment, a system 10 is provided for monitoring the horn 12, which, in this embodiment, is manually operable via a pushbutton 22, or automatically operable via a horn drive switch 24. The horn drive switch 24 is part of, integrated with or in electrical communication with the OBC 20. Further, the pushbutton 22 and/or the horn drive switch 24 is in electrical communication with and used to interact with or otherwise cause the activatable mechanism 16 (in this embodiment, an activatable valve 26) to open, thereby causing the locomotive horn 12 to sound.

In this non-limiting embodiment, the monitoring device 18 is in communication with the OBC 20, the horn valve 26 and/or some other component of the locomotive horn system. As discussed, the monitoring device 18 is capable of measuring the presence or absence of some measurable characteristic, e.g., physical, electrical and/or aural characteristic, and may transmit a signal to the OBC 20 based upon the results of this measurement. For example, this signal or feedback can be transmitted to a horn monitoring component 28 of the OBC 20.

In one preferred and non-limiting embodiment, the OBC 20 includes a display mechanism 30 or some other indicator of the results of the measured/monitored horn system 14. For example, the display mechanism 30 may be in communication with or otherwise integrated with the OBC 20, the horn system 14 and/or the horn monitoring component 28. Further, this display mechanism 30 is configured to present data, e.g., to the operator, a user, an engineer, a central monitoring system, a control system, etc., based upon the signal (measurement) transmitted from the monitoring device 18, the signal processed by the horn monitoring component 28 and/or as some indication of the measured characteristic or any combination thereof. The data may be collated, modified or otherwise interpreted and presented to the user, vehicle operator or central controller in a variety of manners, e.g., textual, visual, graphical, audible, etc. In this manner, the user could make an assessment regarding the status of the horn system 14, and may, if necessary, take the appropriate corrective action.

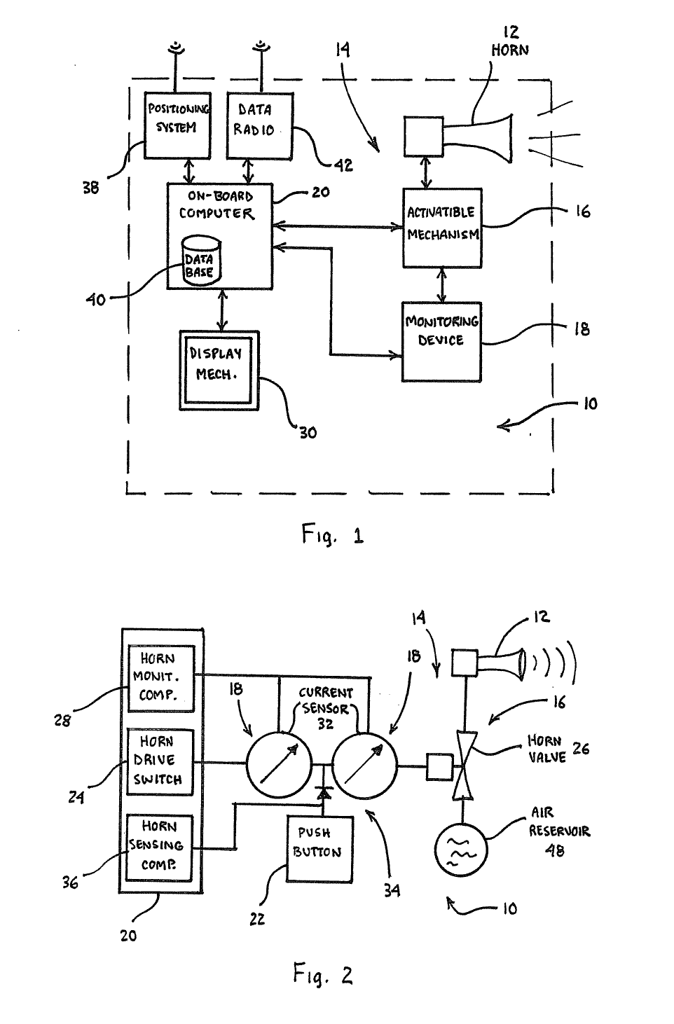

As seen in FIG. 2, the monitoring device 18 is a current sensor 32. This current sensor 32 is positioned in a horn activation circuit 34. The current sensor 32 is positioned between the horn drive switch 24 and the horn valve 26, which, in this embodiment, is an electrically-controlled, pneumatic horn valve. In automated operation, when the horn drive switch 24 is activated, electrical current flows through and to the horn valve 26, and the current sensor 32 detects or measures this current, if present.

Under normal operation, current will be present when the switch horn drive switch 24 is closed (or activated), however, the current sensor 32 also provides ability to sense current when the horn drive switch 24 is opened (or deactivated). Further, the current sensor 32 is configured to measure a lack of, or the absence of, current when the horn drive switch 24 is closed. In either case, both such conditions would constitute a “fault” in the system 10, and some indication, message, alarm, etc. would be provided to the operator, such as on the display mechanism 30 of the OBC 20, indicating that the horn activation circuit 34 can no longer provide for the appropriate and automated activation of the horn 12, e.g., automatic horn sequencing and the like.

In another preferred and non-limiting embodiment, a periodic or scheduled computer-controlled self-test of the system 10 could take place by closing the horn drive switch 24 for a short period of time to confirm that current flows when the horn drive switch 24 is closed. Such a test could cycle in a quick enough manner, such that the pneumatic portion of the system 10 would not activate (thereby sounding the horn 12). In this manner, there could be a periodic or scheduled testing of the system 10 without any nuisance (unnecessary) horn 12 activations.

As also illustrated in FIG. 2, and in an alternative, exemplary embodiment, the current sensor 32 is positioned in another portion of the horn activation circuit 34, namely in the electrical path between the pushbutton 22 and the horn valve 26. In this embodiment, a horn sensing component 36 is provided, and this horn sensing component 36 is capable of measuring or otherwise sensing actuation of the pushbutton 22 by the operator. If the pushbutton 22 is pressed, and the current sensor 32 senses the absence of current flow to the horn valve 26 (based upon knowledge of this actuation from the horn sensing component 36), the system 10 and, in particular, the horn monitoring component 28 would register a “fault” in the system 10. Such a “fault” would indicate that the pushbutton 22 is inoperable, or some other problem has arisen with the horn activation circuit 34, and a warning or other alarm could be displayed to the operator, such as on the display mechanism 30. It is also envisioned that the pushbutton 22 is in the form of any known actuatable or activatable switch, button, lever or structure.

As is known in the art, in order to effect automated activation or sequencing of the horn 12, other components and systems in communication (or integral) with the OBC 20 may be utilized. For example, the train's OBC 20 may ascertain the train position based upon a positioning system 38, which is in communication with a database 40 of locations where the horn 12 should be activated. Similarly, a data radio 42, or transceiver, may be used for communications between the OBC 20 and various, upcoming wayside units (not shown). These components and systems operate, function and communicate as is known in the art.

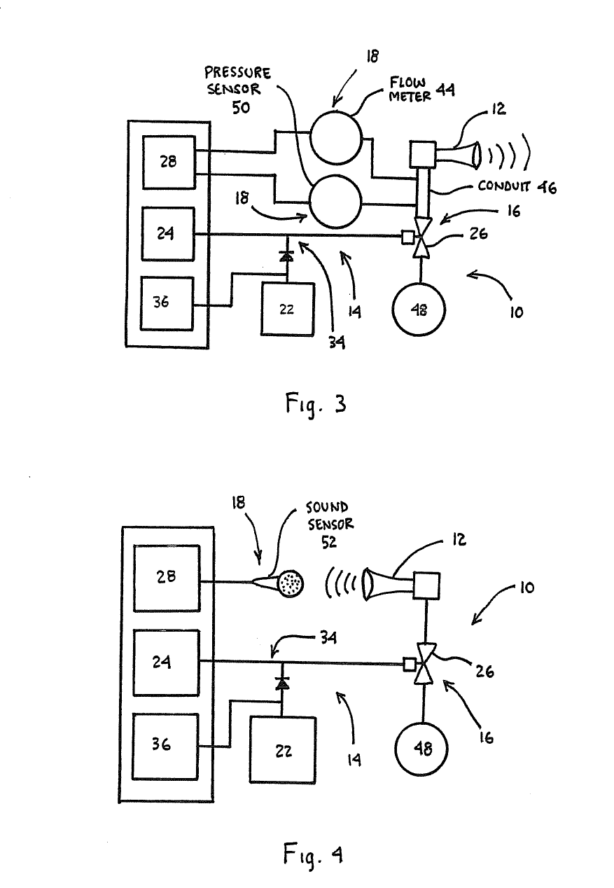

In another preferred and non-limiting embodiment, and as illustrated in FIG. 3, the monitoring device 18 is a flow meter 44. This flow meter 44 would, as discussed above in connection with the current sensor 32, be placed in communication within the horn activation circuit 34. In particular, the flow meter 44 would be placed within or in communication with a conduit 46 extending between the horn valve 26 and the horn 12. In this embodiment, the horn 12 is a pneumatically-driven horn that is activated through pressurized air input. Accordingly, an air reservoir 48 is also in communication with the horn valve 26.

In operation, and whether automatically driven using the horn drive switch 24 or manually activated using the pushbutton 22, the horn valve 26 is activated. Air from the air reservoir 48 flows through the horn valve 26 and is used to sound the horn 12. In this non-limiting embodiment, the flow meter 44 would monitor, sense and/or measure the presence or absence of air flow from the air reservoir 48 through the horn valve 26. It is also envisioned that a pressure sensor 50 be used as the monitoring device 18 in place of the flow meter 44. The pressure sensor 50 would sense the presence or absence of pressure within the conduit 46 connecting the horn valve 26 and the horn 12.

As discussed above in connection with the previous embodiment, the flow meter 44 (or pressure sensor 50) is in communication, e.g., electrical communication, with the horn monitoring component 28 of the OBC 20. Since the OBC 20 includes such a horn monitoring component 28, the horn drive switch 24 and the horn sensing component 36, it is capable of determining if the horn 12 has been instructed to “sound”, whether automatically or manually. Based upon this knowledge, together with the presence or absence of air flow or pressure through the conduit 46, the system 10 can indicate whether there is some malfunction or fault in the horn activation circuit 34 of the horn system 14.

Again, the system 10 may allow for a computer-controlled self-test that could occur by activating the horn drive switch 24, or otherwise instructing the horn valve 26 to open, for a very short period of time. However, enough time should be allowed to lapse in order to confirm that air flow or pressure is detected. However, the instant that air flow or pressure is detected, or should be detected, the horn valve 26 may be shut prior to activation and sounding of the horn 12. Accordingly, the system 10 may confirm proper operation of the horn system 14 without a “full blast” of the horn 12.

In a further preferred and non-limiting embodiment, the monitoring device 18 is a sound sensor 52. As discussed above, the monitoring device 18 (in the form of this sound sensor 52) is in communication with a horn monitoring component 28. The remaining components and portions of the system 10 operate as discussed above.

In this embodiment, the actual aural, or sound, output of the horn 12 is monitored in order to determine if the horn activation circuit 34 is operating appropriately. While a sound sensor 52 is discussed, any combination or type of monitoring device 18 is envisioned, such as a combination of the current sensor 32 used in connection with a horn magnet valve 26, a flow meter 44 sensing air through the pneumatic horn activation circuit 34, or other similar arrangements.

When using the sound sensor 52 of this embodiment, this sensor 52 may be in the form of a microphone that is capable of providing feedback that sound is actually emanating from the horn 12. In addition, the sound sensor 52 and/or the horn monitoring component 28, may be configured and/or calibrated to provide an accurate measurement or comparison of the sound of the horn 12 against some fixed threshold. Accordingly, and in this non-limiting embodiment, the system 10 may be capable of monitoring compliance with various Federal regulations regarding minimal audio output levels of a locomotive horn 12.

Further, if some horn activation signal (whether initiated manually or automatically) is present, but no electrical current, air flow or sound is present, the system 10 would indicate that the horn activation circuit 34 is not operating properly. Similarly, if too little sound is being emitted from the horn 12, the system 10 may also provide such an indication to the operator. This “fault” indication may be presented directly to the operator of the locomotive, or may even be conveyed via a wireless radio network (e.g., the data radio 42) to some operations or maintenance center for disposition and repair.

It is further envisioned that the monitoring device 18, such as in some similar form to the sound sensor 52, is also capable of recording or otherwise recognizing the actual sequence of the horn 12. This would provide an additional compliance check that the operator (manual) and/or the horn drive switch 24 (automatic) is causing the horn 12 to sound in the required sequence, including at the appropriate time and position on the track, as well as the duration and other characteristics of the blast. Again, using the horn monitoring component 28, the OBC 20 may log the compliance data, provide some indication or alert to the operator or communicate this compliance data to central dispatch. Accordingly, not only may the level of the sound emanating from the horn 12 be tracked, but the actual sequence of activation of the horn 12 may also be monitored and analyzed.

It is further envisioned that the OBC 20, or some other component of the train control system may be configured to act upon the faulty condition determination in order to minimize the failure in the horn activation circuit 34. For example, an aural or visual alert may be communicated to the operator by the OBC 20, or any other suitable component, such as on the display mechanism 30. In addition, a message or some communication may be transmitted to central dispatch (or a control center) to log the faulty operation, such that repairs can be immediately initiated upon arrival of the locomotive at an upcoming service depot.

In this manner, the present invention provides a system and method of monitoring in a horn system 14 to ensure appropriate and/or proper operation of the horn 12. The system 10 is capable of monitoring and verifying the integrity of a vehicle horn system 14 and ensures that the horn system 14 (or horn activation circuit 34) is operational, and the horn 12 appropriately activated. The presently-invented system 10 and method is particularly useful in connection with a locomotive in a railway system, but is equally useful in connection with monitoring the appropriate operation of horns and similar safety equipment in a variety of vehicles and situations. All such variations are contemplated within the context of the present application.

The invention has been described with reference to the desirable embodiments. Obvious modifications and alterations will occur to others upon reading and understanding the preceding detailed description. It is intended that the invention be construed as including all such modifications and alterations insofar as they come within the scope of the appended claims or the equivalents thereof.

What is claimed is:

1. A system for monitoring in a horn system of a vehicle having at least one activatable mechanism for causing a horn to sound, the system comprising:
at least one monitoring device in communication with the at least one activatable mechanism, at least one component of the horn system or any combination thereof,
wherein the at least one monitoring device is configured to:
measure the presence or absence of at least one measurable characteristic in the horn system; and
transmit a signal based upon the results of the measurement.

2. The system of claim 1, wherein the measurable characteristic is current, air flow, pressure, sound, physical, electrical, aural or any combination thereof.

3. The system of claim 1, further comprising an on-board computer in communication with the horn system and configured to control at least one component of the vehicle.

4. The system of claim 3, wherein the activatable mechanism is activated automatically via a horn drive switch in communication with the on-board computer.

5. The system of claim 3, further comprising a horn monitoring component in communication with the on-board computer and configured to receive and process the signal transmitted from the monitoring device.

6. The system of claim 5, further comprising a display mechanism in communication with the on-board computer, the horn system, the horn monitoring component or any combination thereof, wherein the display mechanism is configured to present data based upon the signal transmitted from the monitoring device, the processed signal, an indication of the measured characteristic or any combination thereof.

7. The system of claim 1, wherein the activatable mechanism is a valve, a pneumatically-driven horn valve, an electronically-controlled horn valve or any combination thereof.

8. The system of claim 1, wherein the activatable mechanism is activated manually by an operator through actuation of a button positioned within the vehicle.

9. The system of claim 1, wherein the at least one monitoring device is a current sensor configured to sense the presence or absence of current flowing to the activatable mechanism.

10. The system of claim 1, wherein, prior to measurement of the characteristic, at least one component in direct or indirect communication with the activatable mechanism is activated.

11. The system of claim 10, wherein the component is a switch in a horn activation circuit, the switch moveable from an open position, which prevents the flow of current to the activatable mechanism, to a closed position, which permits the flow of current to the activatable mechanism.

12. The system of claim 10, wherein the component is a pushbutton, which can be activated to initiate the flow of current to the activatable mechanism.

13. The system of claim 1, wherein the at least one monitoring device is a flow meter configured to sense the presence or absence of air flowing to the activatable mechanism.

14. The system of claim 1, wherein the at least one monitoring device is a pressure sensor configured to sense the presence or absence of pressure in a conduit in fluid communication with the activatable mechanism.

15. The system of claim 1, wherein the activatable mechanism is activated and the at least one monitoring device measures the at least one measurable characteristic, and the activatable mechanism is deactivated prior to the horn sounding.

16. The system of claim 15, wherein the activation and deactivation of the activatable mechanism is automated.

17. The system of claim 1, wherein the at least one monitoring device is a sound sensor configured to sense sound waves emanating from the horn.

18. The system of claim 17, wherein the sound sensor is a microphone configured to provide feedback indicating that sound is actually emanating from the horn upon activation of the activatable mechanism.

19. The system of claim 1, wherein the at least one monitoring device is a sensor capable of measuring, recording and/or recognizing a sequence of discrete, spaced sounds emanating from the horn.

20. The system of claim 1, further comprising an alarm mechanism configured to provide an aural and/or visual alert to be provided to an operator based upon the signal transmitted by the monitoring device.

21. A method for monitoring in a horn system of a vehicle having at least one activatable mechanism for causing a horn to sound, the method comprising:
measuring the presence or absence of at least one measurable characteristic in the horn system; and
transmitting a signal based upon the results of the measurement.

22. A system for monitoring in a horn system of a vehicle having an on-board computer configured to transmit a signal to at least one activatable valve for causing a horn to sound, the system comprising:
at least one monitoring device in communication with the on-board computer, the at least one activatable valve, at least one component of the horn system or any combination thereof,
wherein the at least one monitoring device is configured to:
measure the presence or absence of at least one measurable characteristic in the horn system; and
transmit a signal based upon the results of the measurement.
